(19) United States
(12) Patent Application Publication
(10) Pub. No.: US 2007/0067354 A1
(43) Pub. Date: Mar. 22, 2007

(54) Productivity suite to line of business synchronization mechanism

(75) Inventors: Maarten W. Mullender, Duvall, WA (US); David Koronthaly, Sammamish, WA (US); Jared R. Parker, Bothell, WA (US); Thomas K. Gersten, Redmond, WA (US); Todd J. Abel, Redmond, WA (US); Lawrence M. Sanchez, Kirkland, WA (US); Rolando Jimenez Salgado, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/437,430

(22) Filed: May 19, 2006

Related U.S. Application Data
(60) Provisional application No. 60/717,694, filed on Sep. 16, 2005.
(60) Provisional application No. 60/752,971, filed on Dec. 21, 2005.
(60) Provisional application No. 60/753,337, filed on Dec. 21, 2005.

(51) Int. Cl. G06F 17/30

(52) U.S. Cl. 707/201

(57) ABSTRACT

A synchronization method is arranged to permit synchronization between a productivity suite application and a line of business (LOB) application such as a Customer Relation Management or CRM application. Requests are sent from the productivity suite application to the LOB application via a web service call to update, delete, or create a new entity in the LOB application. The LOB application extracts each request from received web service calls, where the request can be provided in an XML data representation. Requests are communicated to the productivity suite application via control messages that are embedded in an email to update, delete, or create an item in the productivity suite application, where the item is associated with a LOB entity. The control messages are hidden from the user, and extracted from the email message for evaluation, conflict resolution, property promotion and binding between the LOB entity and the productivity suite application item.

### RELATED APPLICATIONS

This utility patent application claims the benefit under 35 United States Code § 119(e) of U.S. Provisional Patent Application No. 60/717,694 filed on Sep. 16, 2005, of U.S. Provisional Patent Application No. 60/752,971 filed on Dec. 21, 2005, and of U.S. Provisional Patent Application No. 60/753,337 filed on Dec. 21, 2005, which are hereby incorporated by reference in their entirety.

### BACKGROUND OF THE INVENTION

There are a number of productivity suites available to users that include applications for calendaring events, storing contact information, supporting email, storing task information, etc. One example is Microsoft Outlook® available from Microsoft Corporation, Redmond, Wash. Microsoft Outlook® is part of the Microsoft Office® productivity suite. Many users are familiar with such productivity suite applications and use them on a regular basis.

Some productivity suite users also use business software applications or systems developed for particular business uses (also referred to herein as Line of Business or LOB systems). One example is Customer Relationship Management (CRM) systems available from a number of companies. Much information that is managed by LOB systems may include contact management, calendaring of events and tasks, to name a few.

In many cases the productivity suite cannot exchange or synchronize information with the LOB system in automatic manner. For example, if a user adds a business task in the user's productivity suite, the task information will not automatically migrate over to the LOB system. Instead, the information is discovered by the user in each different system. Typically, the user will have to enter the task information for a second time in the LOB system. Some users may want to allow LOB information to be stored in the email systems and synchronized with the LOB information in backend systems.

### SUMMARY OF THE INVENTION

In accordance with various aspects of the disclosed embodiments, a synchronization method is arranged to permit synchronization between a client machine that includes a productivity suite application and a server machine that includes a line of business (LOB) application. The productivity suite application may be a personal information manager (PIM) application such as Outlook® (available from Microsoft Corporation, Redmond, Wash.), or some other application such as Lotus Notes, Star Office, etc. Example productivity suite applications include email management, appointment management, scheduling/calendaring management, notes management, task management, contact management, and others. Synchronization can be handled between data items in the productivity suite application and entities in the LOB application by use of XML data representations and stored binding information.

In one particular implementation, information that is used for synchronization is stored in an XML data representation. The XML data representation can be stored as a property for the data item in the productivity suite application. The XML data representation can be communicated to the LOB application, which can then handle its own conflict resolution and data storage for LOB entities. Changes to entities in the LOB application can then be provided as an XML, which can subsequently be formatted into a control message that is communicated to the productivity suite application. The XML data representations provide for a uniform interface that is simply managed by each respective application.

In another aspect, encryption of the information is performed on a per user basis. This aspect can advantageously help ensure that the information contained in any PIM item that is sent to an email recipient cannot be read by that recipient and thus cannot be shared inadvertently. In a related aspect, the encryption helps prevent the information from causing unexpected behavior on the recipient's side. For example, in some conventional systems, information contained in appointments can easily be shared when sending invites for the appointment. Thus the user may share information without even being aware. The encryption of the information prevents such an occurrence of inadvertent sharing of information. However, in the case where the user has multiple devices, the described encryption will not prevent the information from being shared across the user's multiple devices.

In another aspect, the information is stored in a personal property, reducing the chance of overwriting. In some conventional systems, information can be implicitly exchanged with the invitees in an appointment request without the requestors awareness. When the requestor and invitee share the information, either by sending the information explicitly or implicitly, there is the possibility that the information will be stored in the same property. Since the last stored information will be maintained, the information from one of the users may be overwritten. In one aspect of the present disclosure, a specific property name is assigned to store the additional information such that conflicts are avoided.

In another aspect, the information can be promoted and demoted so that elements or attributes of the information (i.e., which is in XML) can be replicated to properties in the containing PIM items. For example, in one implementation, the standard Microsoft Outlook® UI may be used to display or manipulate these values and/or the values may be shared with other users. In one aspect of the present disclosure, an XML data representation is provided to the LOB application so that LOB items can only be changed by the LOB application. In another aspect, the LOB item is formatted in an XML data representation that is then utilized for synchronizing with the productivity suite application items. Since XML can be utilized as the mechanism for transferring information, simplified user interfaces can be implemented for the productivity suite application.

In another aspect, dialogs are mutually synchronized between the productivity suite and the LOB application. The dialogs can be developed in any appropriate language such as, for example, an extensible application markup language (XAML). The synchronization between dialogs advantageously allows for multiple dialogs showing the exact same item to be opened simultaneously. When the user enters information in one dialog, the information is automatically changed at all other places where it is being shown. For example, in a Microsoft Outlook® implementation, when the same information is shown in a Microsoft Outlook® dialog (Inspector) and in the task pane or action pane, these need to be synchronized. This aspect provides mechanisms that allow multiple dialogs in Microsoft Outlook® to share the same instance of data (while in the process of editing).

In still another aspect, a productivity suite application on a client machine is configured to sends requests via a web server call to update, delete, or create a new entity in the LOB application. The LOB application extracts the request from the client machine, where the request can be provided in an XML data representation. The server machine sends requests via control messages that are embedded in an email to update, delete, or create an item in the productivity suite application, where the item is associated with a LOB entity. The control messages are hidden from the user, and extracted by the client machine for evaluation, conflict resolution, property promotion and binding between the LOB entity and the productivity suite application item.

In a further aspect, an LOB application can communicate an LOB identifier in an email communication, where the LOB identifier is associated with a previous binding between a productivity suite item and a LOB entity. The LOB identifier can be embedded in an email communication in the header associated with the email message. The email communication does not need to contain (embedded or otherwise) the LOB entity itself since the LOB identifier refers to the LOB entity. Once the email message is received, the email handler for the productivity suite can identify a specific productivity suite item in a synchronization shadow or synchronization data store that by reference to the LOB identifier. In one example, the user can access the productivity suite item by selecting a link (e.g., a URL link in any number of forms such as HTTP, HTTPS, FTP, FTPS, OBA, etc.), and other embedded information (e.g., an XML data representation, or other data representation) that is associated with the LOB identifier in the email message. In another example, an action pane or task pane can be activated for access to the specific productivity suite item. Since the LOB identifier can be embedded in a link, any desired action associated with the productivity suite item can be taken by configuring the handler (e.g., a URL handler) appropriately.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram representing an example general computer environment that can be used to implement the techniques described herein, according to an embodiment.

FIG. 2 illustrates an example system where a client device is arranged for synchronization with a LOB system.

FIG. 3 illustrates how the correlation between a bound item and a LOB entity is set when a new bound item is created by the LOB system.

FIG. 4 illustrates how the correlation between a bound item and a LOB entity is set when a new bound item is created in the productivity suite.

FIG. 5 illustrates how the correlation between a bound item and a LOB entity is changed when a bound item is updated or deleted in the productivity suite.

FIG. 6 illustrates how the correlation between a bound item and a LOB entity is changed when a bound item is updated or deleted by the LOB system.

FIG. 7 illustrates an example communication flow between a client and server during a push operation.

FIGS. 8 and 9 illustrate a pull operation that can be employed in another example system.

FIG. 10 illustrates an example design of the synchronization subsystem for a productivity suite that is used on a client machine.

FIG. 11 illustrates another example communication flow between a client and server.

FIG. 12 illustrates an example synchronization subsystem.

FIG. 13 is a flow chart for an example synchronization method.

### DETAILED DESCRIPTION

Various embodiments are described more fully below with reference to the accompanying drawings, which form a part hereof, and which show specific example embodiments for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Briefly stated, a synchronization method is arranged to permit synchronization between a client machine that includes a productivity suite application and a server machine that includes a line of business (LOB) application such as a Customer Relation Management or CRM application. The client machine sends requests via a web server call to update, delete, or create a new entity in the LOB application. The LOB application extracts the request that is received from the client machine, where the request can be provided in an XML data representation. The server machine sends requests via control messages that are embedded in an email to update, delete, or create an item in the productivity suite application, where the item is associated with a LOB entity. The control messages are hidden from the user, and extracted by the client machine for evaluation, conflict resolution, property promotion and binding between the LOB entity and the productivity suite application item.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Various modules, techniques and methods may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

Example Computing Environment

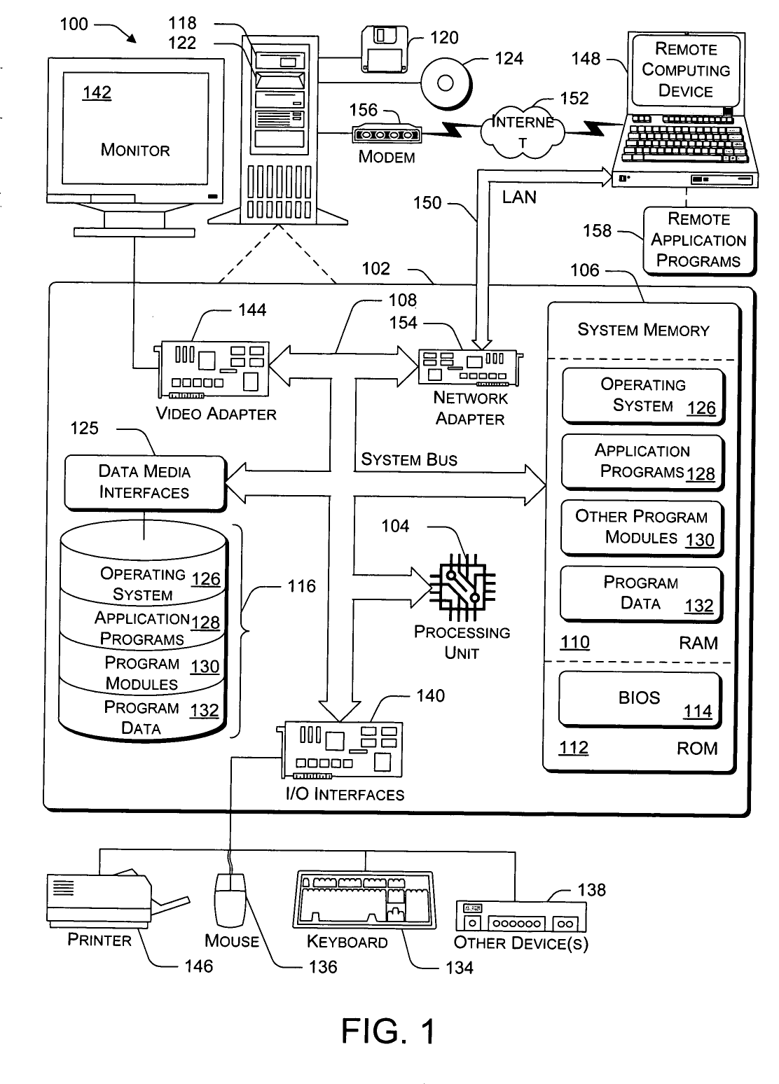

FIG. 1 illustrates a general computer environment 100, which can be used to implement the techniques described herein. The computer environment 100 is only one example of a computing environment and is not intended to suggest any limitation as to the scope of use or functionality of the computer and network architectures. Neither should the computer environment 100 be interpreted as having any dependency or requirement relating to any one or combination of components illustrated in the example computer environment 100.

Computer environment 100 includes a general-purpose computing device in the form of a computer 102. The components of computer 102 can include, but are not limited to, one or more processors or processing units 104, system memory 106, and system bus 108 that couples various system components including processor 104 to system memory 106.

System bus 108 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394, i.e., FireWire, bus.

Computer 102 may include a variety of computer readable media. Such media can be any available media that is accessible by computer 102 and includes both volatile and non-volatile media, removable and non-removable media.

System memory 106 includes computer readable media in the form of volatile memory, such as random access memory (RAM) 110; and/or non-volatile memory, such as read only memory (ROM) 112 or flash RAM. Basic input/output system (BIOS) 114, containing the basic routines that help to transfer information between elements within computer 102, such as during start-up, is stored in ROM 112 or flash RAM. RAM 110 typically contains data and/or program modules that are immediately accessible to and/or presently operated on by processing unit 104.

Computer 102 may also include other removable/non-removable, volatile/non-volatile computer storage media. By way of example, FIG. 1 illustrates hard disk drive 116 for reading from and writing to a non-removable, non-volatile magnetic media (not shown), magnetic disk drive 118 for reading from and writing to removable, non-volatile magnetic disk 120 (e.g., a “floppy disk”), and optical disk drive 122 for reading from and/or writing to a removable, non-volatile optical disk 124 such as a CD-ROM, DVD-ROM, or other optical media. Hard disk drive 116, magnetic disk drive 118, and optical disk drive 122 are each connected to system bus 108 by one or more data media interfaces 125. Alternatively, hard disk drive 116, magnetic disk drive 118, and optical disk drive 122 can be connected to the system bus 108 by one or more interfaces (not shown).

The disk drives and their associated computer-readable media provide non-volatile storage of computer readable instructions, data structures, program modules, and other data for computer 102. Although the example illustrates a hard disk 116, removable magnetic disk 120, and removable optical disk 124, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 116, magnetic disk 120, optical disk 124, ROM 112, and/or RAM 110, including by way of example, operating system 126, one or more application programs 128, other program modules 130, and program data 132. Each of such operating system 126, one or more application programs 128, other program modules 130, and program data 132 (or some combination thereof) may implement all or part of the resident components that support the distributed file system.

A user can enter commands and information into computer 102 via input devices such as keyboard 134 and a pointing device 136 (e.g., a “mouse”). Other input devices 138 (not shown specifically) may include a microphone, joystick, game pad, satellite dish, serial port, scanner, and/or the like. These and other input devices are connected to processing unit 104 via input/output interfaces 140 that are coupled to system bus 108, but may be connected by other interface and bus structures, such as a parallel port, game port, or a universal serial bus (USB).

Monitor 142 or other type of display device can also be connected to the system bus 108 via an interface, such as video adapter 144. In addition to monitor 142, other output peripheral devices can include components such as speakers (not shown) and printer 146 which can be connected to computer 102 via I/O interfaces 140.

Computer 102 can operate in a networked environment using logical connections to one or more remote computers, such as remote computing device 148. By way of example, remote computing device 148 can be a PC, portable computer, a server, a router, a network computer, a peer device or other common network node, and the like. Remote computing device 148 is illustrated as a portable computer that can include many or all of the elements and features described herein relative to computer 102. Alternatively, computer 102 can operate in a non-networked environment as well.

Logical connections between computer 102 and remote computer 148 are depicted as a local area network (LAN) 150 and a general wide area network (WAN) 152. Such networking environments are commonplace in offices, enterprise-wide computer networks, intranets, and the Internet.

When implemented in a LAN networking environment, computer 102 is connected to local network 150 via network interface or adapter 154. When implemented in a WAN networking environment, computer 102 typically includes modem 156 or other means for establishing communications over wide network 152. Modem 156, which can be internal or external to computer 102, can be connected to system bus 108 via I/O interfaces 140 or other appropriate mechanisms. It is to be appreciated that the illustrated network connections are examples and that other means of establishing at least one communication link between computers 102 and 148 can be employed.

In a networked environment, such as that illustrated with computing environment 100, program modules depicted relative to computer 102, or portions thereof, may be stored in a remote memory storage device. By way of example, remote application programs 158 reside on a memory device of remote computer 148. For purposes of illustration, applications or programs and other executable program components such as the operating system are illustrated herein as discrete blocks, although it is recognized that such programs and components reside at various times in different storage components of computing device 102, and are executed by at least one data processor of the computer.

Following is a description of example interfaces and configuration implemented in Microsoft Outlook® to support synchronization of Microsoft Outlook® information with a LOB system. In other embodiments, different productivity suite applications can be used instead of or in addition to Microsoft Outlook®.

Example Configuration

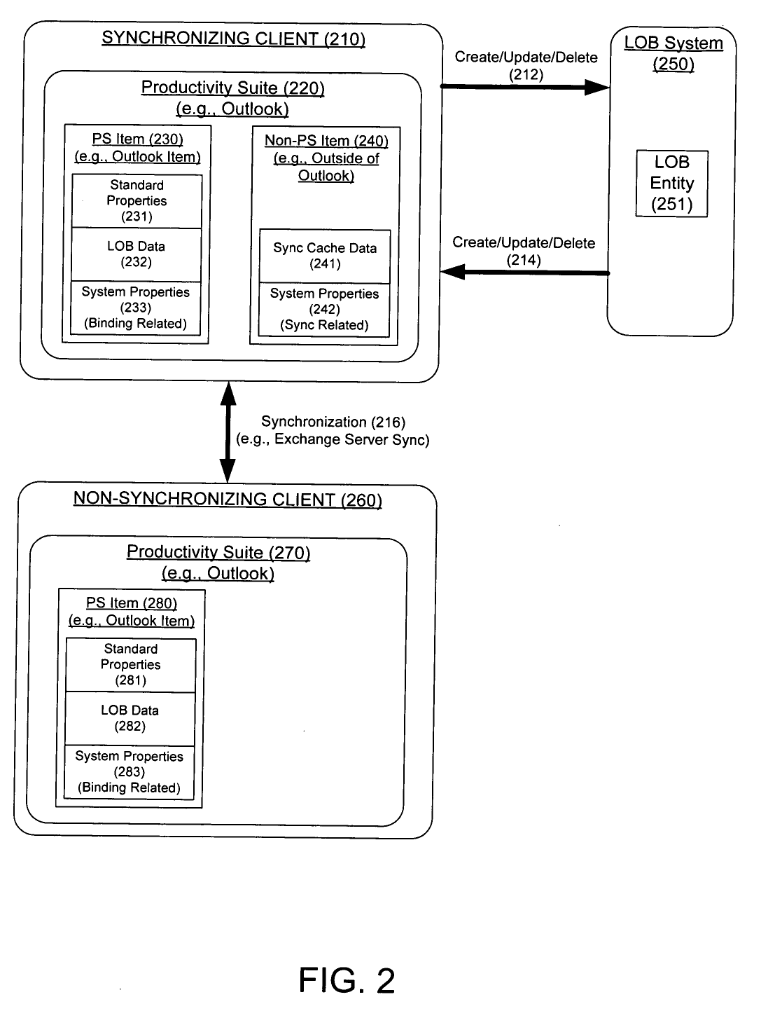

FIG. 2 illustrates an example system where a client device is arranged for synchronization with a LOB system. As shown in the figure, a Productivity Suite (220) such as Microsoft Outlook® is available on a client device. Microsoft Outlook® maintains one or more items such as: calendar appointments, contacts, email, etc. Each productivity suite item (230) includes a set of standard properties (231) that relate to the productivity suite, and a one or more data items (LOB Data 232) that are related to the LOB system. Additional system properties are also associated with the item such as may be necessary for binding data and properties to the item (e.g., binding information in system property 233). Outside of the item (240), there is a set of system properties that are related to synchronization (242), as well as a data store that is used to cache synchronization data (241).

A single user must be able to install the client software on multiple machines. However, only the primary machine is able to synchronize with the LOB System. Other machines are considered secondary machines. The LOB System returns a business response synchronously to the primary machine. The LOB system interfaces with a formatter to provide LOB System-originated “commands” to the primary machine such as create, update or delete commands. At any time, there can only be one primary machine. Secondary machines (e.g., client 260), which include their own copy of the productivity suite (270) still contain a copy of the information available on the primary machine, including business and synchronization status of bound Items (e.g., productivity item 280, including properties 281-283). The described system can be arranged to maintain a synchronization cache on a server to distribute business status responses from the server to the secondary clients.

Productivity suite items (e.g., item 230) should hold enough information for the system to recognize and render Bound Items. LOB Data (including promoted properties) should be stored and associated with the productivity suite item. System information stored in productivity suite items should be static. In other words it should not change once it's set to avoid introducing “artificial” synchronization conflicts. The system should store synchronization data and system properties related with synchronization outside of the productivity suite items. A token can that is hidden in a property can be used to designate which machine is the primary. In some instances, the token can be passed so that the primary machine can be changed such as in the case of disaster recovery.

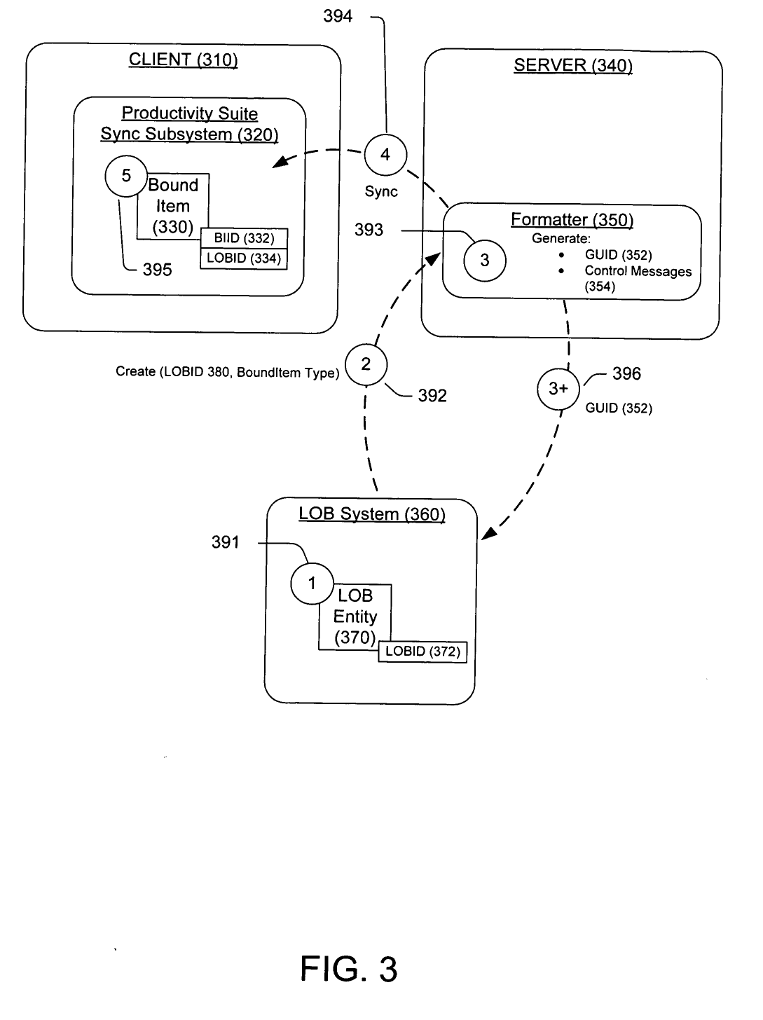

FIG. 3 illustrates how the correlation between a bound item (330) and a LOB entity (370) is set when a new bound item is created by the LOB system. First, the LOB entity (370) is created in the LOB system (360) as designated by step 1 (391), where the LOB entity (370) includes an identifier (LOBID 372). The LOB system (360) communicates a request (392) to the server (340) to create the LOB entity identified by LOBID 372 as a bound item as designated by step 2. The server (340) receives the request (392) and applies a formatter (250) to the request (392), resulting in communication of a command (394) to the primary client (310) to create the binding. The synchronization subsystem (320) for the productivity suite (e.g., Outlook) on the client (310) receives the command (392) during the next synchronization and creates a binding to an outlook item (350) as designated by step 5. The bound item has a unique identifier (BIID 332) that is assigned to it, and is associated with the LOB entity by LOBID 334.

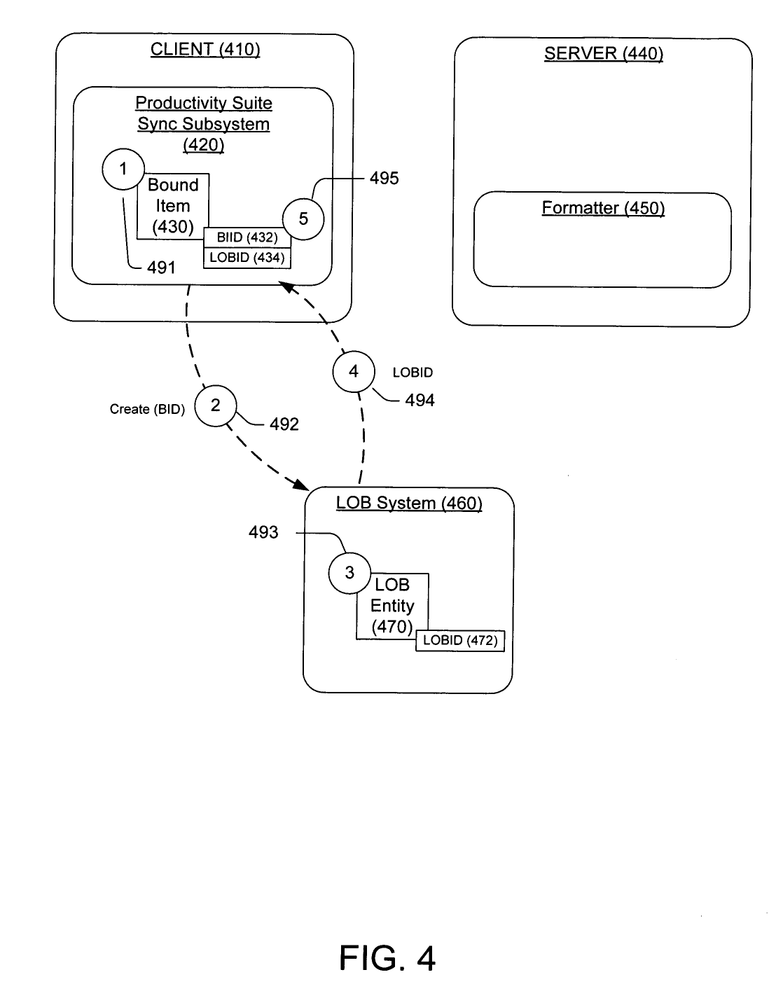

FIG. 4 illustrates how the correlation between a bound item and a LOB entity is set when a new bound item is created in the productivity suite. First, the item (430) is created in the productivity suite as designated by step 1 (491). Next, the synchronization subsystem (420) in the productivity suite (e.g., Outlook) communicates (492) a create binding command to the LOB system (460) as designated by step 2. The LOB system (460) receives the create binding command during the next synchronization with the client, and creates a LOB entity (470) identified by LOBID 472, as illustrate by step 3 (493). The LOB system (460) optionally communicates the LOBID (472) back to the client (410) at step 4 (494), where the client (410) can then associate the LOBID (434) with the bound item (430) as illustrated by step 5 (495). In some instances the LOBID (472) is not communicated back to the productivity suite.

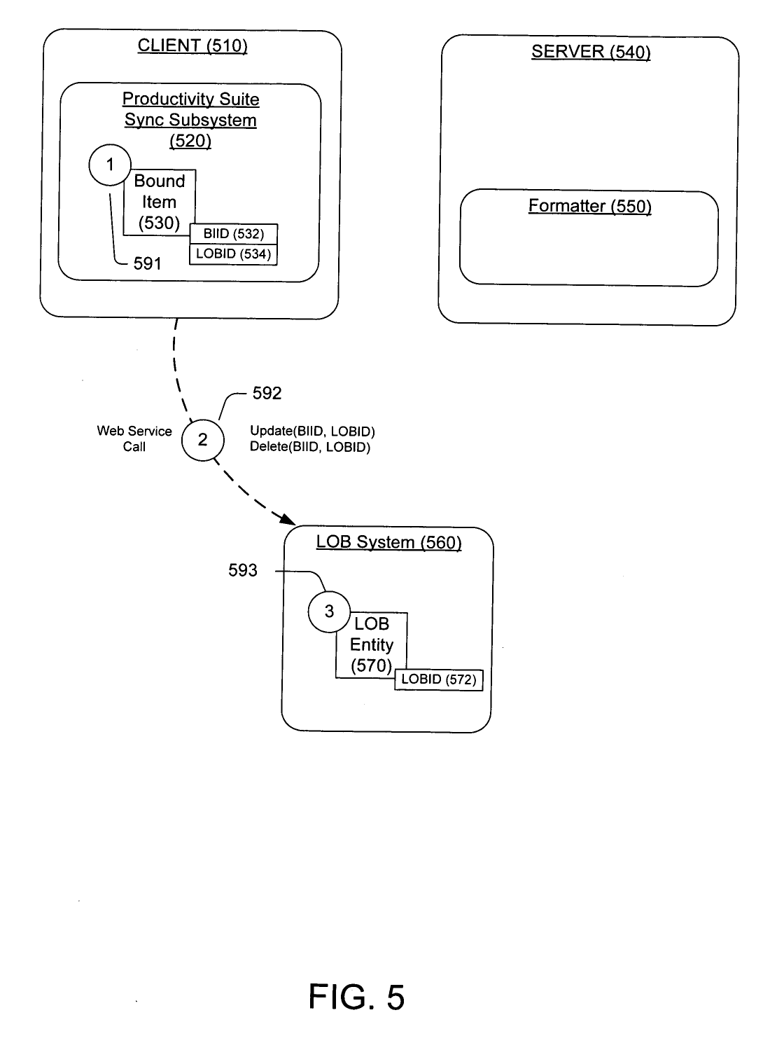

FIG. 5 illustrates how the correlation between a bound item and a LOB entity is changed when a bound item is updated or deleted in the productivity suite. First, the item (530) is changed in the productivity suite as designated by step 1 (591). Next, the synchronization subsystem (520) in the productivity suite (e.g., Outlook) communicates (e.g., through a web service call) either update or delete to the LOB system (560) as designated by step 2 (592). The LOB system (560) receives the update/delete binding command during the next synchronization with the client (510), and modifies or deletes the LOB entity (570) identified by LOBID 572, as illustrate by step 3 (593). In some instances where the LOBID (534) is not known by the productivity suite, the LOB system (560) references the binding identifier BIID 532 to determine which LOB entity (570) to modify or delete.

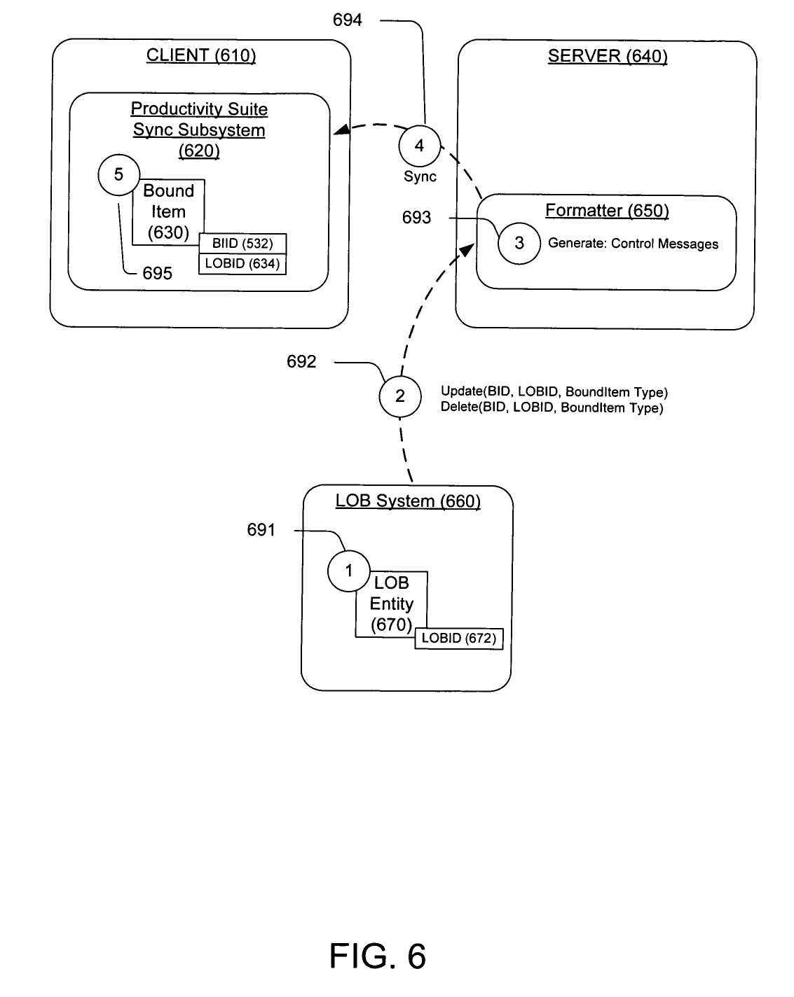

FIG. 6 illustrates how the correlation between a bound item and a LOB entity is changed when a bound item is updated or deleted by the LOB system. First, the LOB entity (670) is modified or deleted in the LOB system (660) as designated by step 1 (691). The LOB system (660) communicates a request (692) to the server (640) to update or delete the LOB entity identified by at least one of the LOBID (672) and the BIID in the request (692) to the server (640). The server (640) receives the request (692) and applies a formatter (650) to the request (692), resulting in communication of a command or control message (694) to change or delete the bound item as designated by step 4. The synchronization subsystem (620) for the productivity suite (e.g., Outlook) on the primary client (610) receives the command during the next synchronization and modifies or deletes the binding (e.g., BIID 532 and LOBUD 634) to the appropriate bound item (630) as designated by step 5 (695).

The synchronization subsystem described above is deployed to client machines that can be inside or outside of a corporate network. Virtual private network or VPN connectivity to the corporate network is expected, as is HTTP type remote synchronization connections via a server application such as Microsoft Exchange Server. LOB Synchronization can run as a background thread on the client device as long as the productivity suite is running. Changes made in the productivity suite are submitted to the LOB system, via any available RPC mechanism (e.g., corporate network, VPN, HTTP, etc.), while changes the LOB system are expected to be made only on the corporate network. File synchronization can be handled in any appropriate way within the corporate network, such as via Microsoft Active Directory, which can be arranged to expose a .NET API for such purposes.

Example Synchronization Interface Definitions

For each Bound Item Type, the synchronization system will execute a different action depending on the change that occurs (create/update/delete). In addition to this, a “Query” action can be invoked as a result of processing a Query Control Message. The following specify the information that needs to be passed into and returned from each of these actions.

Create is invoked by the system whenever a client side Bound Item creation is processed: Parameters for Create include BountItemID, NewItemData, and CultureName. Return values for Create include LOBID, BusinessStatus, and Description. BoundItemID is a client generated unique identifier string for the Bound Item. NewItemData is an XML document that is defined by a schema for the LOB system such that LOB Data for the Bound Item is properly provided. CultureName is the name of the culture that should be used for business status, descriptions and any other messages derived from the Create call. LOBID is a string that is LOB-generated as a unique identifier for the item type (e.g., ContactID uniquely identifies the contact). BusinessStatus is a string that corresponds to a short name of the new business status that must be assigned to the Bound Item as a result of the Create. It is an arbitrary value provided by the LOB System, the sync does not make any assumptions on the contents of this value. The idea is that this value could be used to filter items that are in the same state. Description is an optional string that is an explanation about the BusinessStatus. This will be part of the Bound Item information so it could be exposed Description on the UI if desired.

Update is invoked by the system whenever a client-side Bound Item update is processed. Parameters for Update include BountItemID, RequestID, LOBID. PreviousItemData, NewItemData, and CultureName. Return values for Update include BusinessStatus, and Description. RequestID is a unique identifier for the update message to allow the LOB System to identify duplicates. The same request Id must be sent if a duplicate update message is sent. PreviousItemData is an XML document that corresponds to all LOB Data from the Bound Item from the last synchronized state.

Delete is invoked by the system whenever a client-side Bound Item deletion is processed. Parameters for Delete include BountItemID, LOBID. PreviousItemData, and CultureName. Return values for Delete include BusinessStatus, and Description.

QueryResult is invoked by the system whenever a Query Control Message is processed. The parameter for QueryResult is an XML document containing the list of Bound Item Ids and their corresponding LOBID for all existing Bound Items of the specified type. There are no return values for Query Result.

Example Control Message Definitions

This section specifies the information that is expected in each Control Message type. Control messages include: a Create Control Message, an Update Control Message, a Delete Control Message, and a Query Control Message.

The Create Control Message includes fields for: BoundItemID, LOBID, BoundItemType, and LOBData. The Update Control Message includes fields for: LOBID, BoundItemType, and LOBData. The Delete Control Message includes fields for: LOBID and BoundItemType. The Query Control Message includes a field for BoundItemType.

BoundItemID is a unique identifier to be assigned to the new Bound Item. BoundItemID is generated by the Formatter as will be described in more detail later. BoundItemType is a string that corresponds to a fully qualified name of the Bound Item Type including solution and version. The BoundItemType can be used by the system to locate the corresponding Bound Item Definition, which describes the properties to be bound to the productivity suite item and how the productivity suite item is to be synchronized with the LOB entity. As previously described, LOBID is the unique identifier assigned by the LOB System to the Bound Item, and LOB Data is an XML document containing all of the LOB Data for the Bound Item.

Example Synchronization System

The system can be arranged such that it does not rely on events from the productivity suite (e.g., Microsoft Outlook) to invoke and detect synchronization. In order to detect changes (create/update/delete) the system uses a 3-way synchronization approach, between the productivity suite, a synchronization data store (SDS), and the information obtained directly from the LOB System. Data can be changed from multiple entry points in the system. Information can be changed on many different places including from web access, mobile devices, and from other client machines. Changes will eventually be synchronized to a primacy client machine (e.g., via Outlook/Exchange synchronization).

The LOB System can detect and handle duplicate requests based on a unique Request Id. Outbound (client to server) communication with the LOB System can be made through web services, while inbound (server to client) messages will flow to the clients via the server application (e.g., Microsoft Exchange).

Conflict detection is also handled by the system when the same Bound Item is changed by the LOB System and the productivity suite. If the system detects that the same Bound Item has been updated by the user and the LOB System, a Conflict will be identified and conflict resolution will address it appropriately.

The LOB System supports providing immediate business responses when a synchronous Web Service call is received. The LOB System does not need to receive a confirmation or error notification about successful processing of Create, Update, Delete, or Query commands.

This section describes the high-level communication flows between the LOB System and the Client. The following diagrams provide an overview of possible communication flows that are supported.

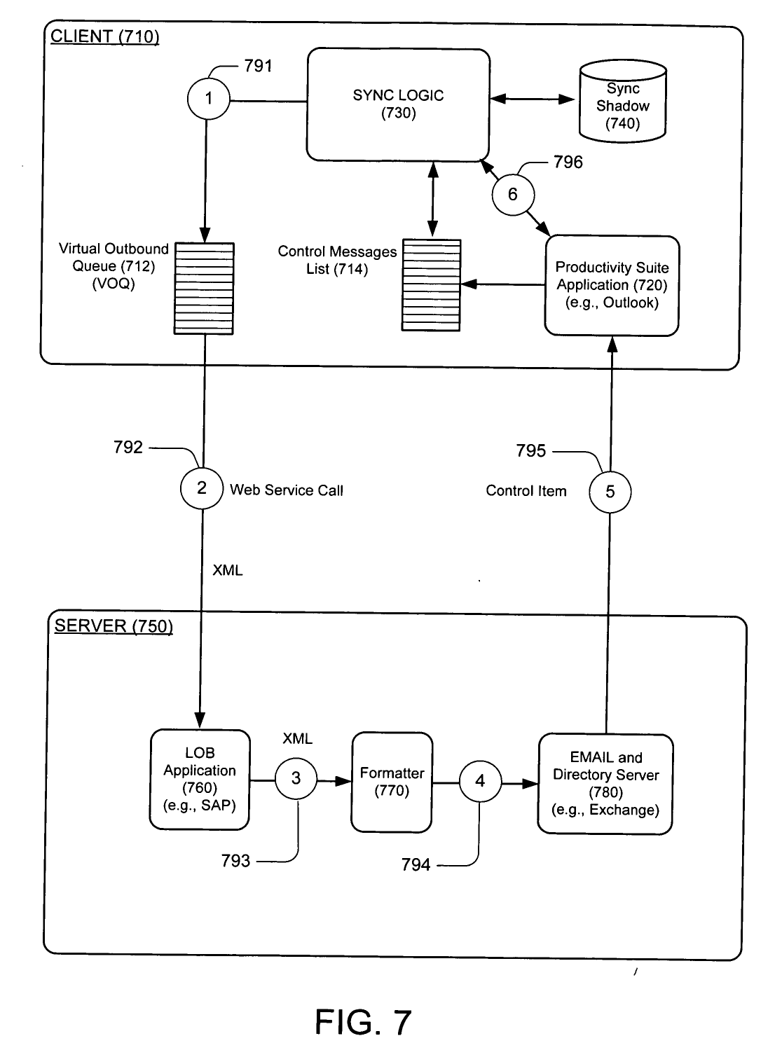

FIG. 7 illustrates an example communication flow between a client and server during a push operation. The push operation can be initiated by the client (710) or the server (750) as will be described.

Step 1 illustrates a client (710) initiated flow, wherein a change detection process is executed by the system on the Client. At step 1, the synchronization logic (730) in the system identifies new, updated and deleted Bound Items and creates (791) a virtual list of change requests that need to be submitted to the LOB System. The virtual list can be provided in a queue such as a virtual outbound queue (VOQ 712). The list is processed when there is connectivity (e.g., web service call 792) to the LOB System (e.g., server 750) at step 2. If no connectivity with the LOB System is identified at step 2, then the list is re-tried the next time the change detection process is run.

When creating the virtual list of requests, the system also takes into account new incoming Control Messages (create, update, delete notifications coming from the LOB System, from Control Message List 714) to detect and resolve or raise conflicts appropriately. A Conflict is detected by the synchronization logic (730) when the same item has been modified in the productivity suite and the LOB System or when one side tries to update an item when the other is trying to delete it. For each detected change (create, update, delete) that does not result in a Conflict, the system submits a request to the LOB System (e.g., server 750) by calling a Web Service (792) such as described in the Synchronization Interface Definitions.

The LOB System (e.g., server 750 with LOB application 760) can also trigger the execution of create, update, delete, or query actions on the client (710) when relevant actions occur on the LOB system. At step 3 the LOB system calls a web service (793) that is exposed by the Formatter (770). In case of create requests, the Formatter (770) returns the Unique Id that will be used by the system to identify the new Bound Item. For details about the information sent as part of the Web Service call see the Synchronization Interface Definitions section discussed herein.

At step 4, the Formatter (770) generates a Control Message (794) and sends it to the specified mailbox associated with the productivity suite (e.g., an Outlook mailbox). The Control Messages (794) are sent from a dedicated account. When the Control Message is delivered to the target mailbox (e.g., by Microsoft Exchange Server, or some other EMAIL and directory server 780) it is automatically moved to a hidden folder by a server-side rule such that accidental deletion of Control Messages is prevented. The server-side rule is maintained (created and re-created) by the Client (e.g., see Outlook Add-in specification for more details).

At step 5, Control Messages (795) are delivered to the Client (710) via an email-type of mechanism that is formatted for the productivity suite application (720). The client (710) processes the Control Messages (795) at step 6 (796) by executing a synchronization process that creates, updates and deletes Bound Items as required. When processing Control Messages, the system also takes into account local changes (create, update, delete of Bound Items) that need to be communicated to the LOB System to detect and flag Conflicts appropriately.

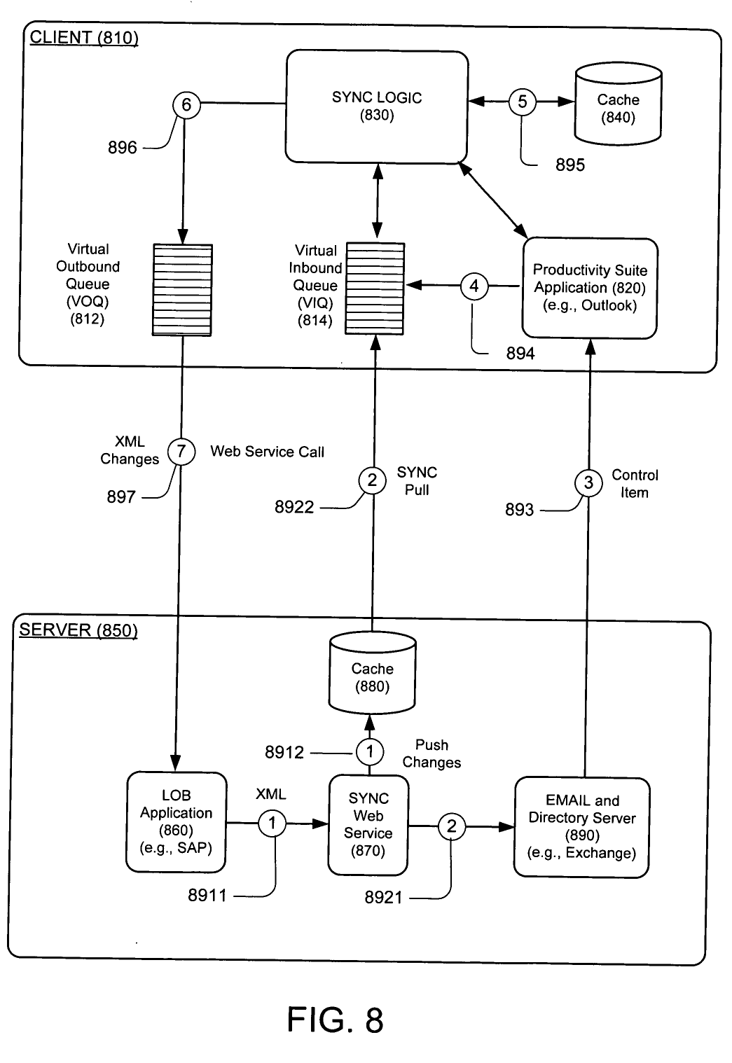

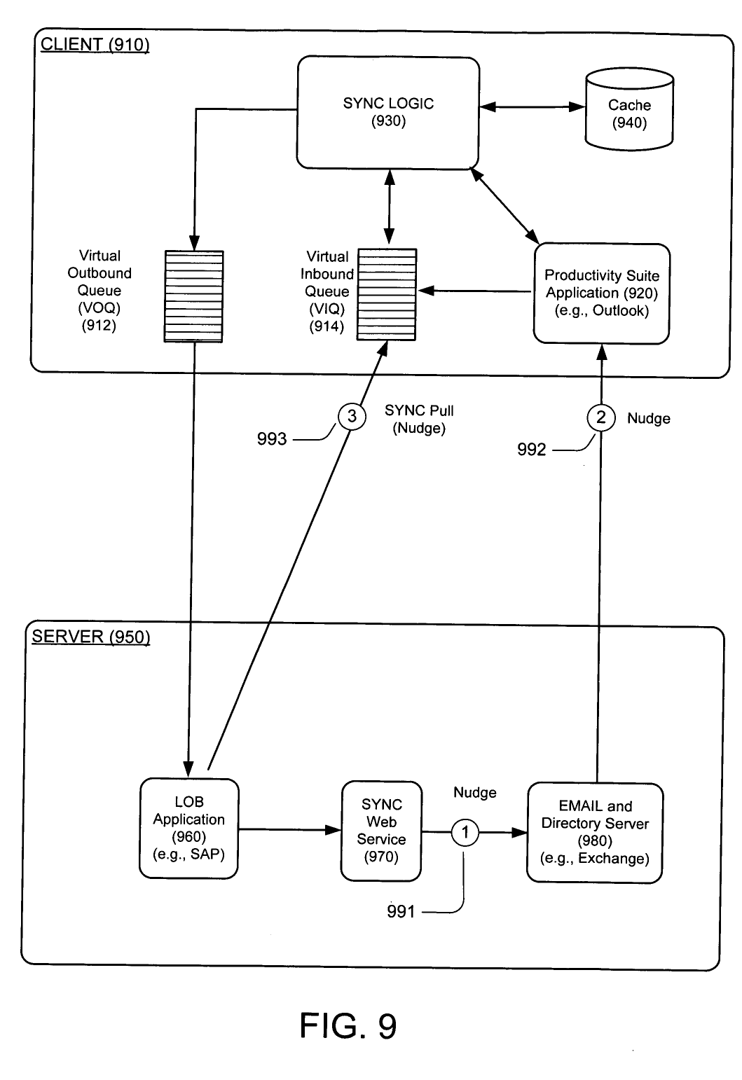

FIGS. 8 and 9 illustrate a pull operation that can be employed in another example system, where the pull can be initiated by a synchronization web service or by a nudge that is imitated by the LOB system.

Synchronization Logic

Bound Items may be changed because the user changes them directly or indirectly through synchronization (e.g. a web access interface). A process is needed that compares the items and determines the differences between the client and the LOB system to decide whether changes on one side should be propagated to the other side.

A change may occur in one of four ways. First, the user may change a Bound Item in the productivity suite. The system detects and automatically submits a change request to the LOB System. Second, the change can be made through another Client and this affects both the productivity suite client through synchronization and the LOB System. The changes to the productivity suite and the LOB System may occur in any sequence with any delay. Third, the change may be made through Smartphone, web access, or any other means and is synchronized via the server to the productivity suite. These changes need to be found through a synchronization process. Fourth, the change can be made in the LOB System itself. Each type of change must be considered by the synchronization process.

A local Synchronization Data Store (SDS) stores the original version. The SDS is synchronized with and subsequently used to track deltas between the productivity suite and the LOB System. The deltas are then added to a virtual request queue containing all the service requests to the LOB System. The update procedures determine when changes need to be propagated to the LOB System. The synchronization logic formulates a request, and submits it to the LOB System when there is connectivity. When updating the productivity suite, the synchronization logic uses the LOB System's information to update Outlook and then updates the SDS.

Most bound data exist in two places: as an item in the productivity suite and in the LOB system. It is assumed that each copy contains additional data that don't exist on the other copy. The synchronization system is responsible for synchronizing: a shared subset of properties stored in the BoundData property of the bound item, and the existence of the bound item, e.g. the item could be created or destroyed as a result of the synchronization. The synchronization system assumes a single definition of truth: the LOB system is always right. At the same time the synchronization system does not have any direct access to LOB entities, and is thus keeping a separate copy in the SDS of what it assumes is stored in the LOB system.

The synchronization process can be divided into several distinct phases. In the sweeping phase all bound items in the mailbox are compared against the SDS. Mismatches in referential integrity between the mailbox and the SDS are detected and immediately fixed. Modified items are detected and marked for further processing. Deleted items are then detected and passed to the synchronizer, so that appropriate delete request can be sent to LOB system. In some implementations, the various phases of the synchronization process described above can be merged into a single integrated process where the various functions (e.g., binding, sweeping, resolving, etc,) can be combined in a simplified algorithm. The simplified algorithm may achieve improve execution speed or achieve some other improved efficiency (e.g., reduce memory/disk usage, eliminate redundancies, etc.).

Any control messages that are identified are processed during the second phase. Next, property promotion occurs for all items that were marked as modified. The resulting updated XML data representation is compared with the SDS copy and the synchronizer is notified. The synchronizer runs in a background thread and in this embodiment uses SDS copies. The synchronizer is responsible for submitting Create, Update and Delete requests as well as processing queries.

The SDS copy contains the same properties mentioned above. Under normal circumstances the EntryID, BoundItemID, BoundItemType and LOBID are the same for the productivity suite item and in the SDS copy. Any differences between the productivity suite item and SDS copy are interpreted as a request to update the LOB entity. If not, the referential integrity is broken and the productivity suite item must be investigated further. The major causes of any differences are: the item has been created by the user, there is no SDS copy for this item yet but the BoundData property is readable, and the item has been copied, moved or deleted by the user, the mapping between EntryID and BoundItemID has been broken; there might be zero, one, or more items all related to a single SDS copy and the BoundData properties are readable, an updated meeting request or task request has been received by the user; it has corrupted corresponding appointment or task (bound item). The EntryID of the item has been preserved but the BoundData property is not readable anymore. A copy of foreign bound item has been received from another user. The BoundData property is not readable and there is no corresponding copy for this item in SDS. A copy or a bound item has been sent to another user, and then it has been sent back. This is a variation of previous possibilities and it cannot be recognized as a special case. A data corruption could have happened.

There is a built-in assumption that BoundItemID is unique (primary key) and that the combination of BoundItemType+LOBID is also unique (secondary key). These restrictions must be enforced in the SDS database. Of course, in the mailbox the EntryID is also unique. Any item where the BoundData property is unreadable or where the duplicate properties stored inside do not match the same properties (BoundItemID, BoundItemType and LOBID) on the Outlook item is considered corrupt. As a general rule, such a corrupt item is automatically unbound. Any duplicate item (when more then one Outlook item has the same BoundItemID) is detected and either converted to a new bound item or unbound; the original is matched with SDS copy (in the case of move we pick one copy).

Communication Flow

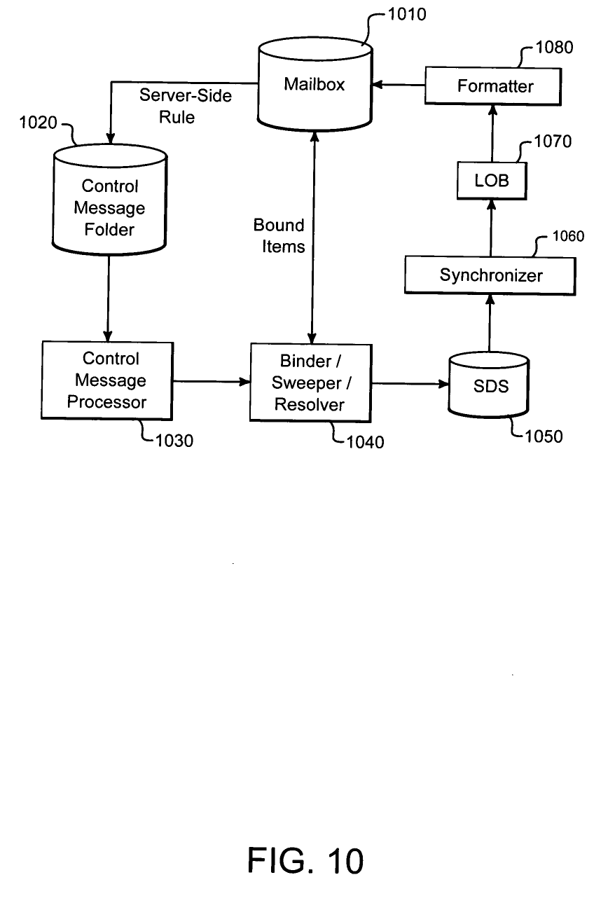

FIG. 10 illustrates another example communication flow between a productivity suite on a client and a LOB system. The LOB system (1070) can initiate updates to bound items via control messages (Create, Update and Delete). The Formatter (1080) service creates control messages as requested by LOB system (1070). The control messages are communicated to the productivity suite via email message in a mailbox (1010). A server side rule moves the control message into a designated (hidden) folder (e.g., control message folder 1020), from which they are picked by a control message processor (1030). Create, Update and Delete requests are processed immediately; while Query requests are queued in a SDS (1050) and are processed by the synchronizer (1060). The Binder/Sweeper/Resolver (1040) service (or services depending on the implementation) is arranged to: compare all bound items in the mailbox (1010) against the SDS (1050), and identify mismatches/changes in the bound items.

Although not a very common, but still important scenario involves the LOB system recreating all bound items for a given user. This can be used to populate the mailbox with initial bound items, as well as part of a disaster recovery when some items have been lost or become corrupt. A variation of this scenario could be used to upgrade existing bound items to a new binding definition (schema). It can also request information about a current state of bound items (Query). Another common use is to send regular mail messages to the user's mailbox (1010); in this case the synchronization system is not involved.

An identity of the sender is used to distinguish valid control messages from unauthorized (or spoofed) control messages. The information in the control message can be encrypted in order to protect its privacy.

The primary machine is responsible for processing control messages, promoting properties, resolving conflicts and submitting updates to LOB. It keeps SDS and mailbox synchronized. The secondary machine can be used to update bound items via UI. It is also building its own SDS database using synchronization, but with some important differences. The secondary machine is not processing control message and does not do property promotion during synchronization, nor does the second machine submit changes to the LOB system. When building a SDS the secondary machine assumes the data in the mailbox is correct. Any failures to update a SDS due to referential integrity issues are silently ignored since it is assumed that the primary machine will eventually resolve the conflict and that the resolution will be propagated to the secondary machine. The important consequence of these rules is that the SDS on the secondary machine does not contain the full state of any pending changes and therefore it cannot be promoted to the primary one.

The server can be arranged to maintain a synchronization cache (e.g., similar to the SDS but excluding the bound data information) for the purposes of distributing business status responses from the server to the various secondary client machines. Periodically, the server can push out changes to the secondary client so that the secondary clients have the latest copy of the relevant SDS data.

Synchronization Subsystem

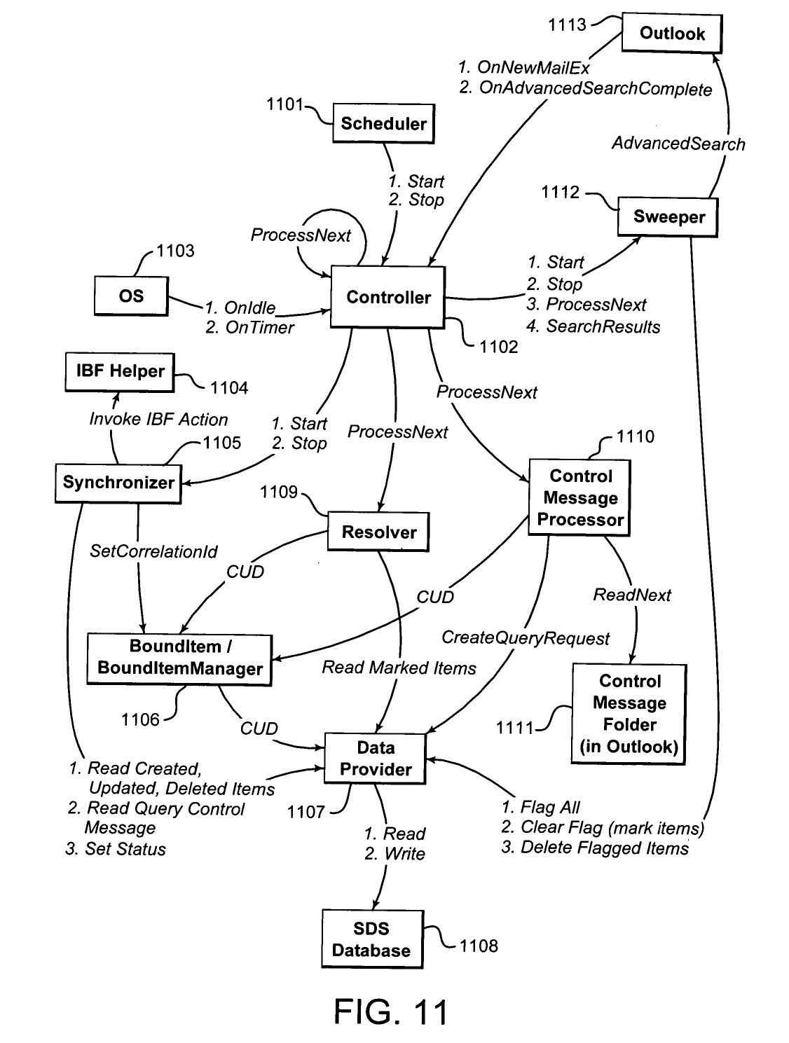

The synchronization subsystem is illustrated in FIG. 11, and is composed of the following major components: a Controller (1102), a Bound Item Manager (1106), a Bound Item Wrapper, a Sweeper (1112), a Resolver (1109), a Control Message Processor (1110), a Data Provider (1107), and a Synchronizer (1105).

The Controller (1102) is a public component used to control the synchronization process.

The Bound Item Manager (1106) is a public component that is used to create and/or directly access the bound items. The Bound Item Wrapper is a public wrapper that encapsulates the productivity suite item as a bound item, or unbinds the item. In some implementations, the functionality of the Bound Item Manager (1106) can be included as part of the Controller (1102), or part of another component.

The Sweeper (1112) is an internal component used to find bound items that need to be investigated (because they have changed since the last synchronization occurred). In some implementations, the functionality of the Sweeper (1112) can be included as part of the Controller (1102), or part of another component.

The Resolver (1109) is an internal component used to investigate bound items and either to resolve the changes locally (via property promotion) and/or to mark them for full synchronization. In some implementations, the functionality of the Resolver (1109) can be included as part of the Controller (1102), or part of another component.

The Control Message Processor (1110) is an internal component used to process control messages from a monitored designated folder (1111) for messages sent by the Formatter. The control messages are processed to update productivity suite items in the case of Create/Update/Delete verbs or to submit Query commands to be processed by the synchronizer component. In some implementations, the functionality of the Control Message Processor (1110) can be included as part of the Controller (1102), or part of another component.

The Data Provider (1107) is an internal component, providing access to the SDS data tables (1108). In some implementations, the functionality of the Data Provided (1107) can be included as part of the Controller (1102), or part of another component.

The Synchronizer (1105) is an internal component responsible for: notifying the LOB systems when Bound Items are created, updated, or deleted on the client, updating the Synchronization Data Store (SDS 1108) after successful notifications, processing Query control messages, and reporting the state of the synchronization process. In some implementations, the functionality of the Synchronizer (1105) can be included as part of the Controller (1102), or part of another component.

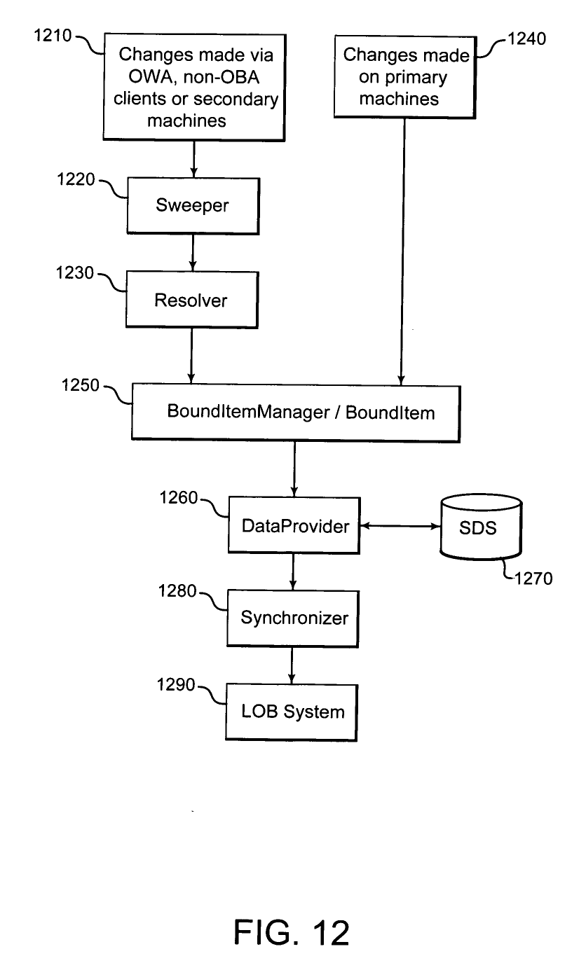

Synchronization of Changes is illustrated by FIG. 12 as follows below. Changes to Bound Items can be made on the primary machine (an OBA enabled machine) or through another external interface such as from a web-service (e.g., Outlook Web Access or OWA), or some other non-OBA enabled clients and mobile devices. Depending on where the changes are made the system will synchronize those using slightly different code paths.

Managing Bound Items: Enabled Clients

The user can create, update and delete Bound Items in a Client that is enabled for synchronization such as through an add-in or plug-in component. The system detects the changes and automatically submits change requests to the LOB System. The request is processed and the LOB System sends back an application level success or failure response. This response is received by the Client and the application business status of the Bound Item is updated. In case of new Bound Items (e.g., created in Outlook), the response from the LOB System is used by the system to correlate the Bound Item with an LOB Entity.

Managing Bound Items: Web Access

The user accesses their mailbox through web access. Bound Items are exposed to the user as standard items. The user can change the standard information normally, but not the extended information. The user can update or delete existing Bound Items, but cannot create new ones, except for the case of copying an existing Bound Item (indirect create). When the user goes back to their primary machine, the changes made through the web access are synchronized by the server application (e.g., through Microsoft Exchange). The system detects the changes and automatically submits the appropriate change requests to the LOB System.

Managing Bound Items: Non-Enabled Clients

The user may access their mailbox using a productivity suite client that is not enabled. Bound Items appear as standard items. The user can change the standard information normally, but not the extended information. The user can update or delete existing Bound Items, but cannot create new ones. The user then synchronizes with the server application (e.g. Microsoft Exchange). When the user goes back to their primary Client machine, the changes made in the non-enabled client are synchronized from the server application. The system detects the changes and automatically submits the appropriate change requests to the LOB System.

Managing Bound Items: Mobile Devices

The user accesses their mailbox through a mobile device. No special support is provided for mobile devices, they are treated just like web access. Bound Items are exposed to the user as standard items. The user can change the standard information normally, but not the extended information. The user can update or delete existing Bound Items, but cannot create new ones. When the user goes back to their primary Client machine, the changes made in the mobile device are synchronized by the server application (e.g., Microsoft Exchange). The system detects the changes and automatically submits the appropriate change requests to the LOB System.

Managing Bound Items: Multiple Enabled Clients

The user has a “primary” client machine and any number of “secondary” client machines, where each machine has an installed client application that enables synchronization between productivity suite applications and the LOB system. The user can create, update or delete Bound Items in any machine. Changes made on one machine will be synchronized to the others via the server application (e.g., Microsoft Exchange), but in one embodiment only the primary machine will be able to synchronize with the LOB System. The “primary” machine is designated at installation time; other machines will be considered “secondary” machines. There is no specific limit to the number of secondary machines a user can have. When connectivity to the LOB System is available on the primary machine, the system will automatically submit the required change requests to the LOB System.

The described system can be arranged such that a synchronization cache is maintained on the server for the purposes of distributing business status responses from the server to the various secondary client machines. For this example, the server's synchronization cache is updated before and after each primary client sweep. The server's synchronization cache may consist of all data from the SDS excluding the BoundData. According to a sweep interval schedule, the server's synchronization cache can be downloaded from the server to each secondary client's own SDS.

Managing Bound Items: Propagation of Changes

When changes to relevant to business entities are made in the LOB System, the server application will be notified via the Formatter. A change notification is delivered to the Enabled Clients that may need to apply the changes to the Bound Item. Since the change notice is pushed out, the clients does not need to ping for an update and can immediately respond without waiting for a scheduled synchronization time.

Synchronization Method

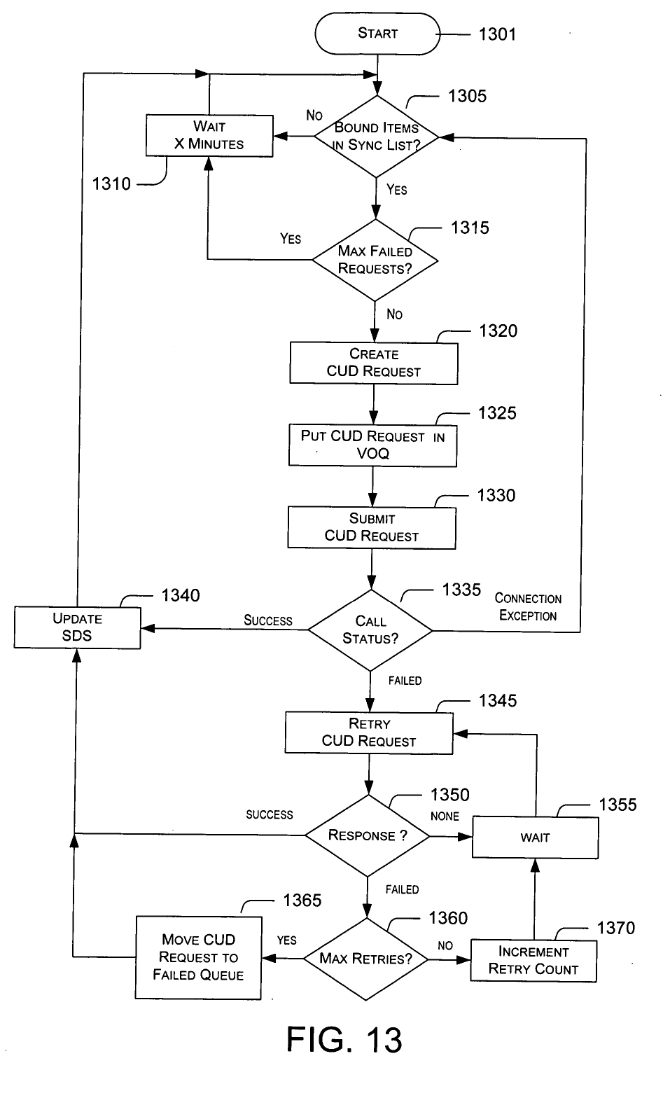

FIG. 13 is a flow chart for an example synchronization method. Periodically, the system Sweeper process can locate and “mark” Bound Items that need to be synchronized, where those items are placed in a logical list for synchronization (Sync List). For each item in the Sync List, a create, update, or delete request (CUD Request) is generated and stored in the outbound queue (e.g., VOQ 712 from FIG. 7). A web service call is then initiated so that a connection can be established to the LOB system. The web service call can succeed, fail, or generate a connection exception.

A successful connection is established when a response is obtained from the LOB in response to the web service call. For a successful connection to the web service, the system updates the bound item copy in the SDS with the information from the response. Additional CUD Requests are processed similarly for each item in the Sync List.

A failed connection results when an exception other than a connection exception is provided from the LOB system in response to the web service call. For a failed connection to the web service, the CUD Request is kept in the outbound queue and marked for retry. A retry count for the CUD request can be initialized when the first failed connection is identified. Retries will continue until either a successful connection is established or the maximum number of attempts permitted over a predetermined time interval reaches a limit. The CUD request is moved to a Failed Requests Queue when the maximum number of attempts permitted is reached without success. Additional CUD requests will not be processed unless a successful connection is achieved.

A connectivity exception can occur when the client has a valid authentication cookie and the ping to the target server fails. The system skips to the next item on the Sync List when the connectivity exception results from a web service call.

An example process flow for synchronization is illustrated by FIG. 13, as will be described below. Processing starts at block 1301, and flows to decision block 1305.

At decision block 1305, the productivity suite synchronization system evaluates the sync list to identify any bound items that need to be synchronized between the productivity suite application and the LOB application. When no bound items are on the sync list, processing flows to block 1310 where the system waits a predetermined time (e.g., X minutes) before evaluating the sync list again. When bound items are found in the sync list, the system determines if the maximum number of failed requests has been reached at block 1315. When the maximum number of requests has been reached, processing again flows to block 1310. Alternatively, processing continues at block 1320 where a CUD request is created.

Continuing to block 1325, the CUD request is placed in an outgoing request queue such as VOQ 712 from FIG. 7. At block 1330, the productivity suite application synchronization system submits each request in the outgoing request queue to the LOB system through a service call such as a web service call. Continuing to decision block 1335, the CUD call request is evaluated to determine if the request was successfully submitted to the LOB system. Processing continues from decision block 1335 to block 1340 (where the synchronization data store or SDS is updated) when the CUD call request is successful. Processing flows from decision block 1335 to block 1345 when the CUD call request fails. In some instances, a connection exception is generated and processing flows from decision block 1335 to decision block 1305.

At block 1345, the synchronization system for the productivity suite application attempts a retry for the CUD call request. At decision block 1350, the system determines if a response is received from the call request. When the response is successful, processing flows from decision block 1350 to block 1340 where the SDS is updated. When the response fails, processing flows from decision block 1350 to decision block 1360. If no response is received, processing continues from decision block 1350 to block 1355, where the system, waits for a timeout to expire before attempting another retry at block 1345.

At decision block 1360, the system determines if the maximum number of retries for the CUD call request has been reached. When the maximum number of retries has been reached, processing continues to block 1365 where the CUD request is moved to a failed queue. When the maximum number of retries has not been exceeded, the system increments an internal retry counter at block 1370, and proceeds to block 1355 to wait for another retry.

Referencing Synchronized Items

As previously described, bindings are created between LOB entities and PS items. While the synchronization system does not have any direct access to LOB entities, the SDS keeps a separate copy of what it assumes is stored in the LOB system. When a binding between an LOB entity and a PS item is created, a copy of the synchronized PS item can be placed in the SDS such that the PS item can be indexed with LOBID associated with the LOB entity. In other words, a PS item that is associated with an LOB entity can be retrieved from the SDS with reference to LOBID. Since the PS item can be retrieved with reference to the LOB ID, a number of interesting applications, plug-ins, or other software methods can be implemented that may utilize the PS item (e.g., a backend workflow system).

In one example, an LOB application can communicate an LOB identifier (e.g., LOBID) to a productivity suite application via an email communication. The email communication includes embedded information that refers to the LOB item. For example, LOBID can be embedded in a header associated with the email message. The email communication does not need to contain (embedded or otherwise) the LOB item itself since the LOBID refers to the LOB entity. Once the email message is received, the email handler for the productivity suite can identify a specific productivity suite item in a synchronization shadow or synchronization data store that by reference to the LOB identifier.

In another example, the user can refer to the productivity suite item with a link (e.g., a URL link in any number of forms such as HTTP, HTTPS, FTP, FTPS, OBA, etc.) that refers to the LOB identifier associated with a PS item in the SDS.

In still another example, an action pane, task pane, or other software methodology such can be activated when the LOB system sends an email message to the productivity suite system. Once activated, the software methodology can retrieve the productivity suite item from the SDS by referencing the LOBID, and then act upon the productivity suite item.

The actions that can be performed on the productivity suite item by the software methodology may result in a create, update, or delete of a productivity suite item, which can then be synchronized with the LOB system as previously described. The LOB system can effectively communicate a task to the productivity suite user by referencing the software methodology and the LOB ID in the email communication.

In one example software methodology, the email communication from the LOB system can communicate a request for the user to complete a review or approval associated with the specific productivity suite item that is synchronized with the LOB entity identified with the LOB ID. The email communication can be communicated automatically by the LOB system when a deadline in the LOB system arrives, or when provided by a specific user of the LOB system. The email can be created by the LOB system by communicating information (e.g., via an XML data representation, via text, via embedded data, etc.) to the formatter, which then cooperates with the EMAIL and Directory Server (see e.g., FIG. 7) to generate the email message. The email can stress the need to finalize an action that is associated with the productivity suite item, provide further explanations, etc., where the email can refer to the tasks in a backend workflow system. Since the productivity suite application can interpret a link embedded in the email communication as a task, the actual task information can be presented automatically. The user can then select, and follow the link to open the task item in the productivity suite application, where the associated synchronized backend information can be stored in an XML data representation. Since the LOB identifier can be embedded in a link, any desired action associated with the productivity suite item can be taken by configuring the handler (e.g., a URL handler) appropriately.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the invention. Since many embodiments of the invention can be made without departing from the spirit and scope of the invention, the invention resides in the claims hereinafter appended.

What is claimed is:

1. A computer readable medium having computer executable instructions for synchronizing information between a line of business (LOB) application and a productivity suite application, the instructions comprising:
receiving a push communicated email with the productivity suite application, wherein a control message is embedded in the push communicated email, wherein the control message is an XML data representation from the LOB application that define changes to a LOB entity;
retrieving the control message from the email with the productivity suite application on the client machine; and
identifying changes to a bound item in response to the retrieved control message during a synchronization process such that the bound item is associated with both a productivity suite item and the LOB entity, wherein the control message indicates at least one of: an LOB entity creation, an LOB entity update, and an LOB entity deletion.

2. The computer readable medium of claim 1, the instructions further comprising: authenticating the email before retrieving the control message such that spoofing from unauthorized senders is prevented.

3. The computer readable medium of claim 1, the instructions further comprising: providing notification to a user when the control message is retrieved from the email.

4. The computer readable medium of claim 1, the instructions further comprising: automatically placing the retrieved control message in at least one of a hidden folder and an inbound message queue.

5. The computer readable medium of claim 1, the instructions further comprising: storing each bound item in a synchronization data store (SDS) on the client machine.

6. The computer readable medium of claim 5, the instructions further comprising: identifying changes between the productivity suite application items and the associated LOB entities with the SDS, and placing requests for the identified changes in a virtual request queue for synchronization with the LOB system.

7. The computer readable medium of claim 5, the instructions further comprising: comparing all bound items in a mailbox for the productivity suite application against the SDS, and detecting and fixing referential integrity between the mailbox and the SDS.

8. The computer readable medium of claim 7, the instructions further comprising: marking modified items for further processing, promoting properties for the marked items; and comparing the resulting updated XML data representation against the SDS copy.

9. The computer readable method of claim 1, wherein the synchronization process comprises at least one of: identifying and resolving conflicts associated with the bound item, promoting a property associated with the bound item, demoting a property associated with the bound item, and updating the bound items without promoting properties when the productivity suite application is assigned to a secondary machine.

10. The computer readable medium of claim 1, the instructions further comprising:
creating an outbound request in response to a change to a productivity suite item on the client machine, wherein the outbound request comprises t least one of a create, update, and delete associated with the productivity suite item;
placing the outbound request in an outbound queue for synchronization with the LOB application;
initiating a web service call for the request in the queue to the LOB application at a first instance of time such that the LOB application can retrieve the outbound request from the web service when the web service successfully connects to the LOB application; and
removing the outbound request from the outbound queue and updating a synchronization data store (SDS) when the web service successfully connects to the LOB application.

11. The computer readable medium of claim 10, the instructions further comprising:
initiating a second web service call for the outbound request in the outbound queue at a second instance of time when the web service initially fails to successfully connect to the LOB application.

12. The computer readable medium of claim 10, the instructions further comprising: encoding the request in an XML data representation for receipt by the LOB application.

13. An apparatus for synchronizing information between a line of business (LOB) application and a productivity suite application, the apparatus comprising:
a processor;
a computer-readable medium;
an operating environment stored on the computer-readable medium and executing on the processor; and
an application operating under the control of the operating environment and operative to perform actions, wherein the application is arranged to:
create a request in response to a change to a LOB entity, wherein the request comprises at least one of an instruction to create the LOB entity, update the LOB entity, and delete the LOB entity;
generate an XML data representation associated with the change in the LOB entity;
format the XML data representation into a control message that is encoded in an email; and
push communicate the email to the productivity suite application such that the changes to the LOB entity can be synchronized with productivity suite application items by extracting the control message from the email.

14. The apparatus of claim 13, wherein the application is further configured to push communicate the email to another productivity suite application that is present on a secondary client.

15. The apparatus of claim 13, wherein the application is further configured to:
receive a web service call;
extract an update request from the web service call, wherein the update request is associated with a change to a productivity suite application item; and
update an LOB entity in response to the extracted update request, wherein the extracted update request corresponds to at least one of an instruction to create the productivity suite application item, update the productivity suite application item, and delete the productivity suite application item.

16. The apparatus of claim 15, wherein the update request from the web service call is another XML data representation.

17. The apparatus of claim 13, wherein the application is further configured to: receive a web service call from the productivity suite application, extract a request from the web service call, and create an LOB entity in response to the extracted request.

18. A method of synchronizing information between a line of business (LOB) application and a productivity suite application, the method comprising:
receiving an XML data representation from the LOB application, wherein the XML data representation identifies changes associated with at least one entity in the LOB application;
formatting the XML data representation into a control message;
embedding the control message in an email; and
push communicating the email to the productivity suite application such that the changes associated with the at least one entity in the LOB application can be synchronized with the productivity suite application.

19. The method of claim 18, further comprising:
receiving an other XML data representation from the productivity suite application;
identifies changes associated with at least one item in the productivity suite application from the other XML data representation; and
updating at least one entity in the LOB application based on the identified changes such that the at least one entity in the LOB application is bound to the at least one item in the productivity suite application.

20. The method of claim 19, wherein updating comprises at least one of: creating, modifying, and deleting the at least one entity in the LOB application.
